(19) United States
(12) Patent Application Publication
(10) Pub. No.: US 2006/0251282 A1
(43) Pub. Date: Nov. 9, 2006

(54) Earphone with built-in microphone

(76) Inventor: Kuo-Tisng Kaoh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/124,083

(22) Filed: May 9, 2005

(51) Int. Cl. H04R 25/00

(52) U.S. Cl. 381/381

(57) ABSTRACT

The present invention is an earphone with a microphone in a whole body for better sound quality and easy use as well as easy manufacturing, which prevents the microphone from protruding, avoids noise around and reduces the size so as to produce a mini size of earphone.

### FIELD OF THE INVENTION

The present invention relates to an earphone; more particularly, relates to making an earphone and a microphone into a whole one so as to obtain functions of both the earphone and the microphone.

### DESCRIPTION OF THE RELATED ART

An earphone with a microphone according a prior art comprises two independent units one for hearing and one for speaking in communication. When using the microphone, it is designed and located beside the mouth so that the noise around the microphone is transmitted through the microphone and the sound quality is so affected. In addition, two independent units of an earphone and a microphone make cost higher, manufacturing harder and usage more inconvenience.

So, the prior art does not fulfill users' requests on actual use.

### SUMMARY OF THE INVENTION

Therefore, the main purpose of the present invention is to provide an earphone with a microphone in a whole body for better sound quality and easy use as well as easy manufacturing.

To achieve the above purpose, the present invention is an earphone with a built-in microphone, where the earphone and the microphone are made into a whole one, comprising an earphone body made of silicon or the like material with an outward sound-receiving hole and an inward speaking hole deposed inside, while the outward sound-receiving hole comprises an outward sound channel extended from the outward sound-receiving hole into the earphone body, an outward microphone corresponding to the outward sound channel, and a sound transmission wire connected from the outward microphone to the outside surface of the earphone body; and while the inward speaking hole comprises an inward sound channel extended and an inward microphone at an opening of the inward sound channel. According to the present invention, sound signals are received from the sound transmission wire to be transmitted to the outward microphone; and sound signals are heard through the outward sound channel and the outward sound-receiving hole; and The sound spoken is transmitted by the inward microphone through the inward speaking hole and the inward sound channel owing to that the seven apertures in the human head are inter-connected and so the sound spoken can be acquired from the ear.

Accordingly, the present invention is a novel earphone with a built-in microphone, which prevents the microphone from protruding, avoids noise around and reduces the size so as to produce a mini size of earphone.

### BRIEF DESCRIPTIONS OF THE DRAWINGS

The present invention will be better under stood from the following detailed descriptions of the preferred embodiments according to the present invention, taken in conjunction with the accompanying drawings, in which

FIG. 1 is a top view of a preferred embodiment according to the present invention

FIG. 2 is a cross-sectional view of a preferred embodiment according to the present invention; and

FIG. 3 is a bottom view of a preferred embodiment according to the present invention.

FIG. 4 is a bluetooth earphone of a preferred embodiment according to the present invention

### DESCRIPTION OF THE PREFERRED EMBODIMENTS

The following descriptions of the preferred embodiments are provided to understand the features and the structures of the present invention.

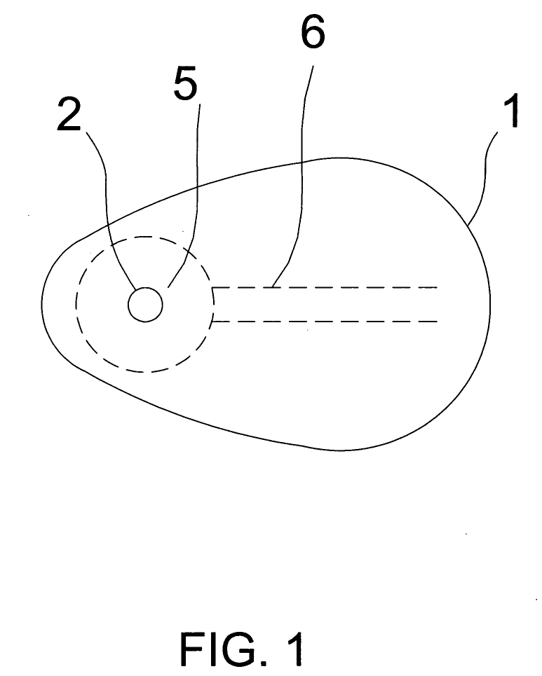

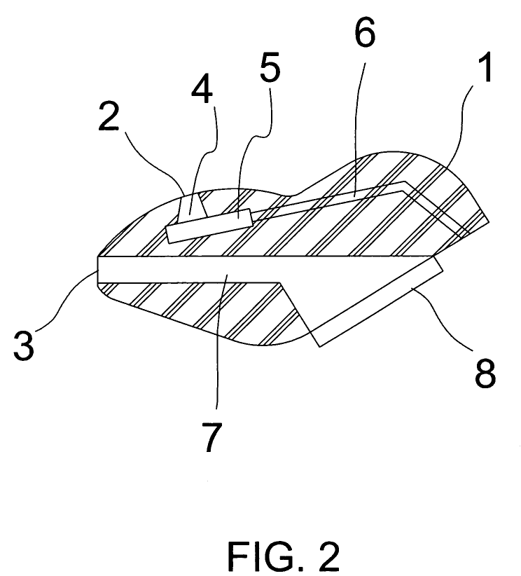

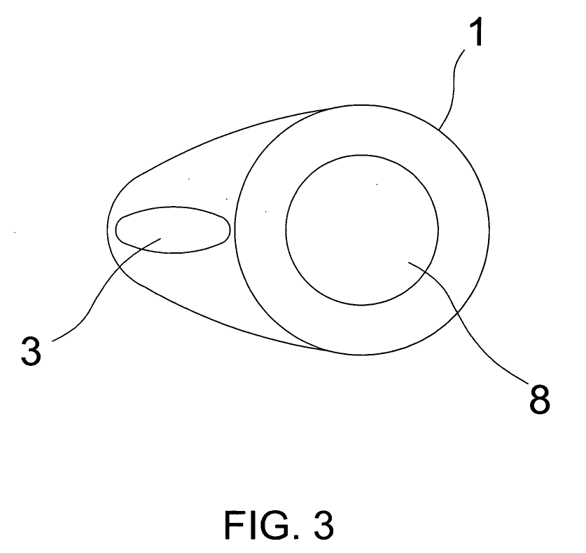

Please refer to FIG. 1 through FIG. 3, which are a top view, a cross-sectional view and a bottom view of a preferred embodiment according to the present invention. As shown in the figures, the present invention is an earphone with a built-in microphone, comprising an earphone body 1 made of silicon or the like material, where an outward sound-receiving hole 2 and an inward speaking hole 3 are both deposed in the earphone body. The outward sound-receiving hole 2 comprises an outward sound channel 4 extended into the earphone body 1 and an outward microphone 5 corresponding to the outward sound channel 4. The outward microphone 5 is embedded with a sound transmission wire 6 to be connected to the outside surface of the earphone body 1. The inward speaking hole 3 connected to an inward sound channel 7 extended and an inward microphone 8 fixed at an opening of the inward sound channel 7. Sound signals are received from the sound transmission wire 6 to be transmitted to the outward microphone 5; and sound signals are heard through the outward sound channel 4 and the outward sound-receiving hole 2. The sound spoken is transmitted by the inward microphone 8 through the inward speaking hole 3 and the inward sound channel 7 owing to that the seven apertures in the human head are inter-connected and so the sound spoken can be acquired from the ear.

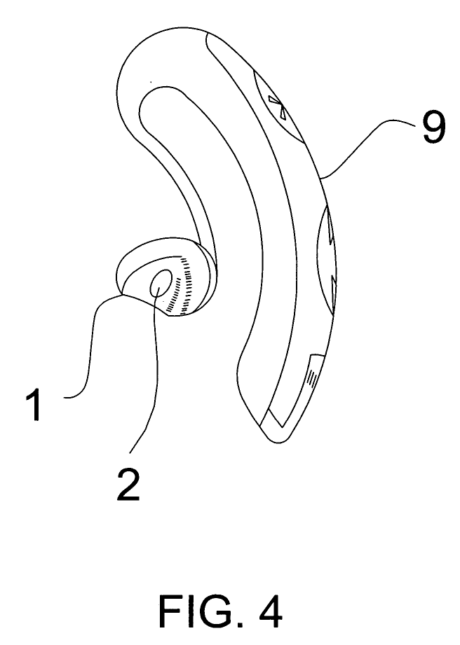

On actual use the built-in microphones according to the present invention can be plugged to a radio, a hi-fi equipment, a telephone, a mobile phone or any other audio device by extending the sound transmission wire 6; or be plugged to a wireless earphone. In a word, the present invention can be applied to a general wire earphone or a small wire earphone; and can be applied to an ear-wearing wireless earphone or audiphone, which is shown in FIG. 4 as a bluetooth earphone.

In the present invention, the microphone is embedded in the earphone to avoid noise around, to improve sound quality and to reduce the size of the earphone by no microphone's protruding out, so that a mini earphone can be made to be used in a wire or wireless or bluetooth earphone or some other audio devices.

To sum up, the present invention is an earphone with a built-in microphone, where an earphone and a microphone are made into a whole one, characterized in that an outward sound-receiving hole and an inward speaking hole are both deposed in the earphone body; and a sound is received by the outward sound-receiving hole through the outward sound channel, the outward microphone embedded in the earphone body, and the sound transmission wire. And, owing to that the seven apertures in the human head are inter-connected, a sound can be received by the inward speaking hole from with in the ear, while a sound can be spoken through the inward sound channel to the microphone fixed at an opening of the inward sound channel.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An earphone with a built-in microphone, comprising:
an earphone body;
an outward sound-receiving hole located at said earphone body, comprising an outward sound channel extended into said earphone body, an outward microphone embedded corresponding to said outward sound channel, and a sound transmission wire connected to the outside surface of said earphone body to receive sound; and
an inward speaking hole located at said earphone body, comprising an inward sound channel extended and an inward microphone at an opening of said inward sound channel,
wherein a sound is spoken out by said inward microphone through said inward speaking hole and said inward sound channel; and a sound from ear is received by said outward microphone through said outward sound-receiving hole and said outward sound channel to be transmitted by said sound transmission wire.

2. The earphone according to claim 1, wherein said sound transmission wire is connected to an audio device selected from a group consisting of a telephone, a mobile phone, an audiphone, a computer, and a hi-fi equipment.

3. The earphone according to claim 1, wherein said sound transmission wire is deposed on ear and is wirelessly connected to an audio device selected from a group consisting of a telephone, a mobile phone, an audiphone, a computer, and a hi-fi equipment.
